(19) United States
(12) Patent Application Publication
(10) Pub. No.: US 2022/0039522 A1
(43) Pub. Date: Feb. 10, 2022

(54) Ornamental Connector

(71) Applicant: Sandra Leeann Giarrusso, Manunda (AU)

(72) Inventor: Sandra Leeann Giarrusso, Manunda (AU)

(21) Appl. No.: 17/299,861

(22) PCT Filed: Dec. 5, 2019
(86) PCT No.: PCT/AU2019/051334

§ 371 Date: Jun. 4, 2021

(30) Foreign Application Priority Data
Dec. 5, 2018 (AU) 2018904625

(51) Int. Cl. A44B 11/00; A44B 11/02; G01S 19/13; A44C 5/18

(52) U.S. Cl. CPC A44B 11/001; A44B 11/02; A44D 2200/10; A44C 5/185; G01S 19/13

(57) ABSTRACT

The present invention relates to an ornamental connector for connecting an ornamental item to and elongate flexible member such as a strap, belt or chain. The ornamental connector includes abase including an aperture a recess for receiving the elongate flexible member, as well as an engaging arrangement for removably connecting an ornamental item. The ornamental connector can further include a locking arrangement for locking the ornamental connector to the base. The ornamental connector can further include a holding arrangement for preventing sliding movement of the ornamental connector along the elongate flexible member.

### FIELD OF THE INVENTION

The present invention relates to fashion accessories in the form of an ornamental connector for attachment to wearable items such as belts, straps or bikinis and the like, and in particular to a means of detachably connecting the ornamental item to the wearable item or any other accessory attached to the user's clothing.

The invention has been developed primarily for use with a strap for use in conjunction with a bikini and will be described hereinafter with reference to this application. However, it will be appreciated that the invention is not limited to this particular field of use.

### BACKGROUND OF THE INVENTION

Presently, there are limited methods of releasable attachment of precious stones and other accessories related to clothing items such as belt buckles and straps. There are advantages associated with the ability to alternate such accessories as it allows one to change the appearance of their fashion items without having to change the entire item, however a reliable means for doing this is currently missing from the fashion landscape.

The present invention seeks to provide a novel means of providing releasable attachment of fashion accessories, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect, the present invention may be said to consist of an ornamental connector for connecting an ornamental item to an elongate flexible member, the ornamental connector comprising:
a. a base, the base including an aperture through which the elongate flexible member is receivable in use;
b. an engaging arrangement configured for removably connecting the ornamental item to the base;
c. wherein the engaging arrangement includes at least one or more engaging formations extending substantially about the periphery of the ornamental item in use, to thereby prevent movement of the ornamental item relative to the base in any direction; and
d. wherein at least one or more of the engaging formations are composed of a resilient material and configured for receiving the ornamental item in an elastically deformable manner.

According to another aspect, the present invention may be said to consist of an ornamental connector for connecting an ornamental item to an elongate flexible member, the ornamental connector comprising:
a. a base, the base including an aperture through which the elongate flexible member is receivable in use;
b. an engaging arrangement configured for removably connecting the ornamental item to the base;
c. wherein the engaging arrangement includes at least one pair of opposed engaging formations, and at least one flange formation engageable with an abutment formation; and
d. wherein at least one or more of the engaging formations are composed of a resilient material and configured for receiving the ornamental item in an elastically deformable manner.

According to another aspect, the present invention may be said to consist of an ornamental connector for connecting an ornamental item to an elongate flexible member, the ornamental connector comprising:
a. a base, the base including an aperture through which the elongate flexible member is receivable in use;
b. an engaging arrangement configured for removably connecting the ornamental item to the base;
c. wherein the engaging arrangement includes at least one or more engaging formations adapted to at least partially enclose the ornamental item in use, to thereby prevent movement of the ornamental item relative to the base in any direction; and
d. wherein at least one or more of the engaging formations are composed of a resilient material and configured for receiving the ornamental item in an elastically deformable manner.

According to another aspect, the present invention may be said to consist of an ornamental connector for connecting an ornamental item to an elongate flexible member, the ornamental connector comprising:
a. a base, the base including an aperture through which the elongate flexible member is receivable in use;
b. an engaging arrangement configured for removably connecting the ornamental item to the base;
c. wherein the engaging arrangement includes an engaging formation, the engaging formation being engageable with the base to move between:
   i. an engaged position in which the ornamental item is securely engaged with the base and is not removable therefrom; and
   ii. a disengageable position in which the ornamental item is removable from the base; and

d. a locking arrangement, the locking arrangement being moveable relative to the base to move between a locked condition and an unlocked condition;

e. wherein the locking arrangement is adapted to prevent movement of the engaging formation from its engaged position.

In one embodiment, the ornamental connector includes an ornamental item.

In one embodiment, the aperture includes a resistance member adapted to restrict movement of the elongate flexible member when in use.

In one embodiment, the resistance member is adjustable between an engaged position and a disengageable position.

In one embodiment, the engaging formations are connector arms.

In one embodiment, the connector arms are opposed.

In one embodiment, the connector arms are oriented in transversely extending directions.

In one embodiment, the connector arms of the engaging arrangement define a pair of opposed slots for receiving complementary shaped lugs on the ornamental item.

In one embodiment, one or both of the ornamental item and the base include securing formations configured for securing the ornamental item and the base in engagement with each other.

In one embodiment, the securing formations include at least one or more flanges located on either or both of the ornamental item and the base, the flanges configured for preventing sliding movement of the ornamental item relative to the base.

In one embodiment, the ornamental item includes an electronic tracking system configured for allowing the tracking of the location of the ornamental item.

In one embodiment, the rotatable engaging formation is rotatable relative to the base to move between its engaged position and disengageable position.

In one embodiment, the locking arrangement is moveable between a locked condition in which it prevents the rotatable engaging formation from moving from the engaged position in use, and an unlocked condition in which the rotatable engaging formation is moveable between the engaged position and the disengageable position.

In one embodiment, the locking arrangement is held in the locked condition by the elongate flexible member in use.

In one embodiment, the locking arrangement includes an aperture that is aligned with the aperture in base for receiving the elongate flexible member in its locked condition.

In one embodiment, the locking arrangement includes a slot for receiving a protrusion of the rotatable engaging formation.

In one embodiment, the engaging arrangement is a protrusion receivable into a slot in the base.

In one embodiment, the engaging arrangement is a T shaped protrusion.

In one embodiment, the engaging arrangement is elongated in one direction.

In one embodiment, the engaging arrangement is elongated in one direction.

In one embodiment, the slot in the base is elongated in one direction.

In one embodiment, the locking arrangement is receivable into one or more selected from an aperture and a recess in the base.

In one embodiment, the locking arrangement is receivable into the base on a track.

In one embodiment, the aperture includes a holding arrangement adapted to restrict movement of the elongate flexible member relative to the ornamental connector when in use.

According to a further aspect, the present invention may be said to consist of an ornamental connector for connecting an ornamental item to an elongate flexible member, the ornamental connector comprising:
a. a base, the base including a recess into which the elongate flexible member is receivable in use;
b. an engaging arrangement configured for removably connecting the ornamental item to the base;
c. wherein the engaging arrangement includes at least one or more engaging formations extending substantially about the periphery of the ornamental item in use, to thereby prevent movement of the ornamental item relative to the base in any direction; and
d. wherein at least one or more of the engaging formations are composed of a resilient material and configured for receiving the ornamental item in an elastically deformable manner.

In one embodiment, the ornamental connector includes an ornamental item.

In one embodiment, the base includes a locking arrangement.

In one embodiment, the locking arrangement includes a locking member.

In one embodiment, the locking member is pivotably movable between an open position and a closed position.

In one embodiment, the locking member includes engaging formations configured for engaging with the ornamental item when the locking member is in its closed position.

In one embodiment, the engaging formations of the locking member complement the engaging arrangement to hold the ornamental item in position.

According to another aspect, the present invention may be said to consist of an ornamental connector for connecting an ornamental item to an elongate flexible member, the ornamental connector comprising:
a. a base, the base including a recess through which the elongate flexible member is receivable in use, the recess being closeable by a closing arrangement to retain the elongate flexible member within the recess;
b. an engaging arrangement configured for removably connecting the ornamental item to the base;
c. wherein the engaging arrangement includes at least one pair of opposed engaging formations, and at least one flange formation engageable with an abutment formation; and
d. wherein at least one or more of the engaging formations are composed of a resilient material and configured for receiving the ornamental item in an elastically deformable manner.

According to a further aspect, the present invention may be said to consist of an ornamental connector for connecting an ornamental item to an elongate flexible member, the ornamental connector comprising:
a. a base, the base including a recess through which the elongate flexible member is receivable in use, the recess being closeable by a closing arrangement to retain the elongate flexible member within the recess;
b. an engaging arrangement configured for removably connecting the ornamental item to the base;
c. wherein the engaging arrangement includes at least one or more engaging formations adapted to at least partially enclose the ornamental item in use, to thereby restrict movement of the ornamental item relative to the base; and
d. wherein at least one or more of the engaging formations are composed of a resilient material and configured for receiving the ornamental item in an elastically deformable manner.

According to a further aspect, the present invention may be said to consist of an ornamental connector for connecting an ornamental item to an elongate flexible member, the ornamental connector comprising:
a. a base, the base including a recess through which the elongate flexible member is receivable in use, the recess being closeable by a closing arrangement to retain the elongate flexible member within the recess;
b. an engaging arrangement configured for removably connecting the ornamental item to the base;
c. wherein the engaging arrangement includes an engaging formation, the engaging formation being moveable relative to the base between:
   i. an engaged position in which the ornamental item is securely engaged with the base and is not removable therefrom; and
   ii. a disengageable position in which the ornamental item is removable from the base;

d. a locking arrangement, the locking arrangement being moveable relative to the elongate flexible member to move between a locked condition and an unlocked condition; and
e. wherein the locking arrangement is adapted to prevent movement of the engaging formation from its engaged position when in its locked condition.

In one embodiment, the ornamental connector includes an ornamental item.

In one embodiment, the locking arrangement is moveable in a direction substantially transversely to the elongate flexible member.

In one embodiment, the locking arrangement includes a closure member.

In one embodiment, the closure member is movable between an open position in which the elongate flexible member is receivable within the recess and a closed position in which the elongate flexible member is restricted from movement into or out of the recess.

In one embodiment, the closure member is pivotably movable between an open position and the closed position.

In one embodiment, the closed position of the closure member corresponds to the locked condition of the locking arrangement.

In one embodiment, the open position of the closure member corresponds to the unlocked condition of the locking arrangement.

In one embodiment, the locking arrangement includes a clasp for retaining the closure member in its closed position.

According to a further aspect, the present invention may be said to consist in an ornamental connector as described above, wherein the ornamental item includes one or more selected from:
a. a geo-positioning/tracking device; and
b. a sensor configured for sensing environmental characteristics.

In one embodiment, the sensor is a UV radiation sensor.

In one embodiment, the sensor is a UV radiation sensor.

In one embodiment, the sensor is configured for sensing one or more selected from UV radiation, when speed, ambient light, or the like.

In one embodiment, the geo-positioning/tracking device is configured for receiving geolocation signals from geo-positioning satellites.

In one embodiment, the ornamental connector includes a processor.

In one embodiment, the ornamental connector includes a transmitter.

In one embodiment, the ornamental connector includes a receiver.

In one embodiment, the ornamental connector includes a power source.

In one embodiment, the power source is a battery.

In one embodiment the ornamental connector includes a power generation device.

In one embodiment, the power generation device is a solar panel.

In one embodiment, the ornamental connector includes a clock device.

In one embodiment, the ornamental connector includes a digital media storage.

In one embodiment, the digital media storage is configured for storing one or more selected from data and software instructions.

In one embodiment, the software instructions are configured for calculating the position of the tracking device.

In one embodiment, the transmitter is configured for transmitting one or more selected from the calculated position of the tracking device and the received geolocation signals from geo-positioning satellites.

In one embodiment, the software instructions are configured for causing the processor to record and/or transmit received UV radiation signals from a UV radiation sensor.

In one embodiment, the processor is configured for receiving UV radiation signals from the UV radiation sensor.

In one embodiment, the software instructions are configured for transmitting the received UV radiation signals from the UV radiation sensor.

In one embodiment, the software instructions are configured for transmitting an alert signal when the detected UV radiation signals are above a predetermined threshold.

In one embodiment, the software instructions are configured for calculating a cumulative amount of UV radiation detected by the UV radiation sensor, and transmitting an alert signal when the cumulative amount of UV radiation detective is above a predetermined threshold.

An ornamental item configured for connection to an ornamental connector as described above, wherein the ornamental item includes one or more selected from:
a. a geo-positioning/tracking device; and
b. a sensor configured for sensing environmental characteristics.

In one embodiment, the sensor is a UV radiation sensor.

In one embodiment, the sensor is a UV radiation sensor.

In one embodiment, the sensor is configured for sensing one or more selected from UV radiation, when speed, ambient light, or the like.

In one embodiment, the geo-positioning/tracking device is configured for receiving geolocation signals from geo-positioning satellites.

In one embodiment, the ornamental connector includes a processor.

In one embodiment, the ornamental connector includes a transmitter.

In one embodiment, the ornamental connector includes a receiver.

In one embodiment, the ornamental connector includes a power source.

In one embodiment, the power source is a battery.

In one embodiment the ornamental connector includes a power generation device.

In one embodiment, the power generation device is a solar panel.

In one embodiment, the ornamental connector includes a clock device.

In one embodiment, the ornamental connector includes a digital media storage.

In one embodiment, the digital media storage is configured for storing one or more selected from data and software instructions.

In one embodiment, the software instructions are configured for calculating the position of the tracking device.

In one embodiment, the transmitter is configured for transmitting one or more selected from the calculated position of the tracking device and the received geolocation signals from geo-positioning satellites.

In one embodiment, the software instructions are configured for causing the processor to record and/or transmit received UV radiation signals from a UV radiation sensor.

In one embodiment, the processor is configured for receiving UV radiation signals from the UV radiation sensor.

In one embodiment, the software instructions are configured for transmitting the received UV radiation signals from the UV radiation sensor.

In one embodiment, the software instructions are configured for transmitting an alert signal when the detected UV radiation signals are above a predetermined threshold.

In one embodiment, the software instructions are configured for calculating a cumulative amount of UV radiation detected by the UV radiation sensor, and transmitting an alert signal when the cumulative amount of UV radiation detective is above a predetermined threshold.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

Other aspects of the invention are also disclosed.

### BRIEF DESCRIPTION OF THE DRAWINGS

Notwithstanding any other forms which may fall within the scope of the present invention, a preferred embodiments of the invention will now be described, by way of example only, with reference to the accompanying drawings in which:

FIG. 1 shows a front view of a first embodiment of an ornamental connector;

FIG. 2 shows a rear view of the ornamental connector of FIG. 1;

FIG. 3 shows a right side view of the ornamental connector of FIG. 1;

FIG. 4 shows a left side view of the ornamental connector of FIG. 1;

FIG. 5 shows a top view of the ornamental connector of FIG. 1;

FIG. 6 shows a bottom view of the ornamental connector of FIG. 1;

FIG. 7 shows a perspective view of the ornamental connector of FIG. 1 in use;

FIG. 8 shows an exploded perspective view of a second embodiment of an ornamental connector;

FIG. 9 shows a perspective cutaway view of the ornamental connector shown in FIG. 8;

FIG. 10 shows a top right front perspective view of a third embodiment of an ornamental connector;

FIG. 11 shows a top right front perspective view of a fourth embodiment of an ornamental connector;

FIG. 12 shows a cross-sectional view of a fifth embodiment of an ornamental connector showing a means of restricting the movement of an elongate member;

FIG. 13 shows a cross sectional view of a sixth embodiment of an ornamental connector showing a locking arrangement;

FIG. 14 shows a cross sectional view of the embodiment of an ornamental connector shown in FIG. 13, showing movement of the holding arrangement;

FIG. 15 shows a cross sectional view of a seventh embodiment of an ornamental connector showing the holding arrangement in an engaged position;

FIG. 16 shows a cross sectional view of the embodiment of an ornamental connector shown in FIG. 15 showing the holding arrangement in a disengageable position;

FIG. 17 shows a top right front perspective view of an eighth embodiment of an ornamental connector with the ornamental item removed;

FIG. 18 shows an exploded top right front perspective view of the ornamental connector shown in FIG. 17;

FIG. 19 shows a front cross-sectional view of the ornamental connector shown in FIG. 17;

FIG. 20 shows a top right front perspective view of a ninth embodiment of an ornamental connector;

FIG. 21 shows a top right front perspective exploded view of the ornamental connector shown in FIG. 20;

FIG. 22 shows a cross-sectional front view of the aperture of the ornamental connector of FIG. 20;

FIG. 23 shows a cross-sectional front view of a tenth embodiment of an ornamental connector;

FIG. 24 shows a top right front perspective exploded view of an eleventh embodiment of an ornamental connector with the holding arrangement in its disengageable position; and

FIG. 25 shows a top right front perspective exploded view of the ornamental connector of FIG. 24 showing the holding arrangement in an engaged position;

FIG. 26 shows a top right front perspective view of a twelfth embodiment of an ornamental connector;

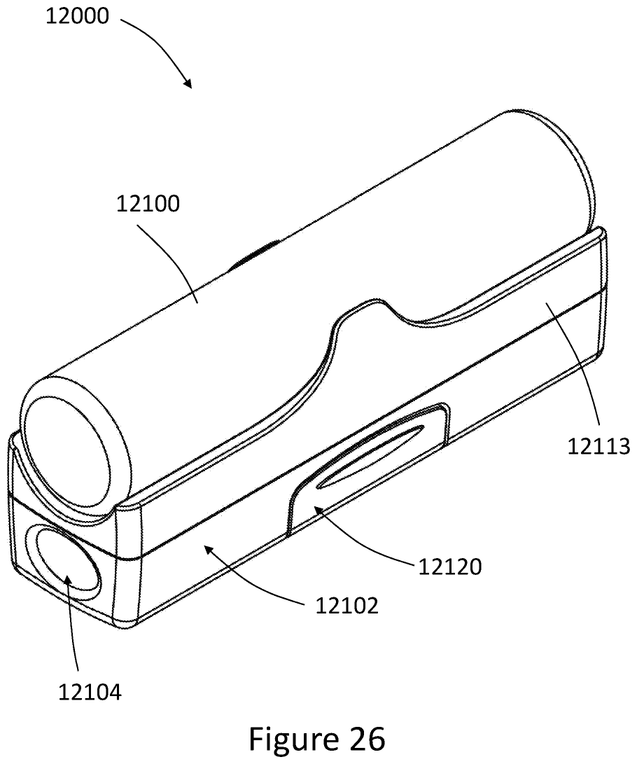

FIG. 27 shows a bottom right front perspective view of the ornamental connector of FIG. 26;

FIG. 28 shows a top right front exploded perspective view of the ornamental connector of FIG. 26;

FIG. 29 shows a cross-sectional front view of the ornamental connector of FIG. 26 attached to a flexible elongate member with the holding arrangement in an engaged position;

FIG. 30 shows a cross-sectional front view of the ornamental connector of FIG. 26 with the ornamental item removed and the holding arrangement in an engaged position;

FIG. 31 shows a top front left perspective view of a thirteenth embodiment of an ornamental connector with the engaging arrangement in an open condition;

FIG. 32 shows a top right front exploded perspective view of a fourteenth embodiment of an ornamental connector with the ornamental item disengaged; and

FIG. 33 shows a schematic view of an ornamental item.

### DESCRIPTION OF EMBODIMENTS

It should be noted in the following description that like or the same reference numerals in different embodiments denote the same or similar features.

An ornamental connector according to a first aspect of the invention is generally indicated by the numeral 1000. Different embodiments of an ornamental connector shown in the figures are indicated by having a different prefix for their numbering.

It is envisaged that an ornamental connector according to the embodiment shown in the figures will be preferably configured for use being connected to a flexible elongate member of a swimsuit, for example a bikini strap, chain or belt.

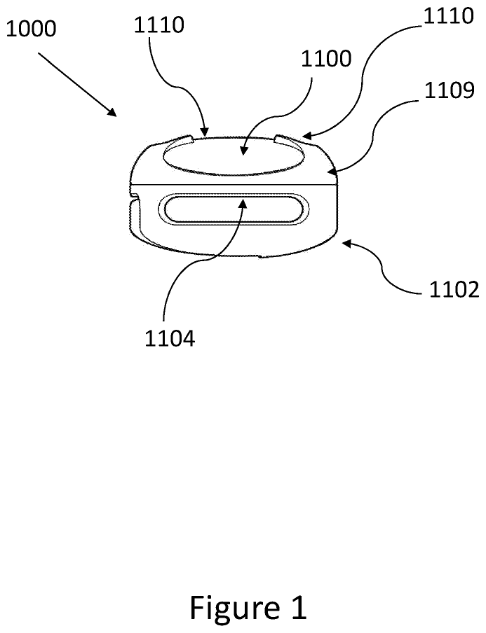

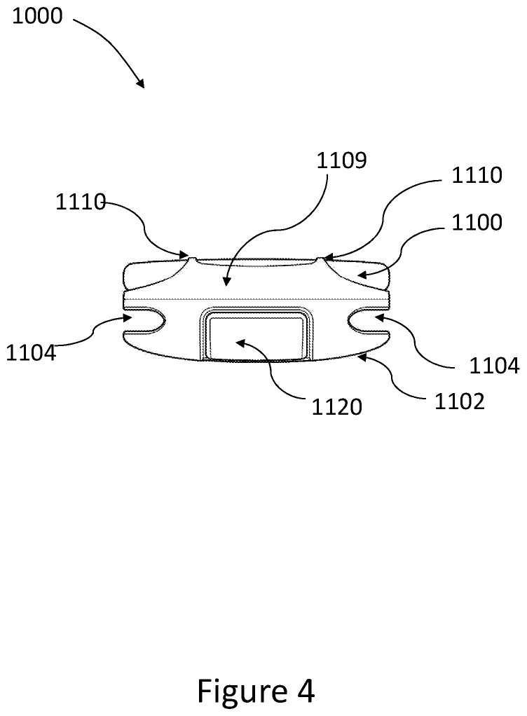

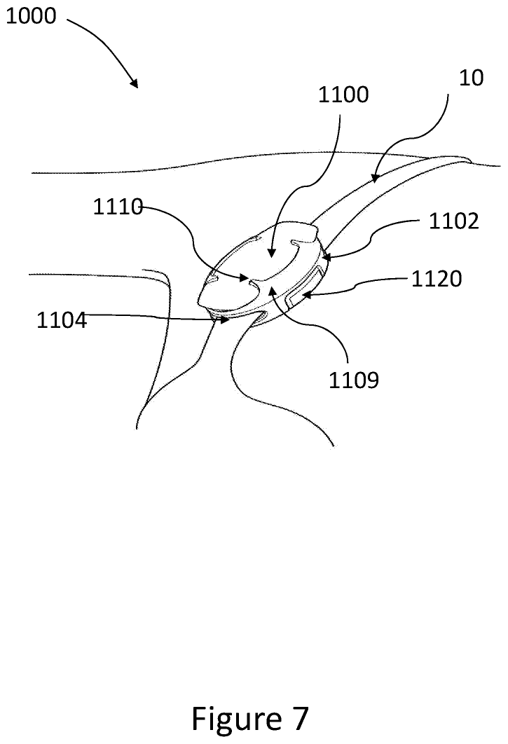

In the embodiment shown in FIGS. 1-7 now described, the ornamental connector 1000 includes a base 1102, an engaging arrangement 1109 and an ornamental item 1100. The ornamental item 1100 is adapted for removal from the engaging arrangement 1109.

The base 1102 includes an aperture 1104 through which an elongate flexible member 10 such as a belt, chain or a strap for a bikini may be threaded or inserted. The base 1102 is connected to an engaging arrangement 1109. The engaging arrangement 1109 is for securely engaging with the ornamental item 1100. The ornamental connector 1000 further includes a holding arrangement 1120 adapted to restrict movement of the elongate flexible member 10 relative to the ornamental connector 1000 when in use.

In order to restrict the movement of the elongate flexible member 10 within the aperture 1104 a holding arrangement 1120 is used. The holding arrangement 1120 is adapted to apply a force onto the elongate flexible member 10 in situ which is particularly advantageous when the elongate flexible member 10 is in the vertical position and may be prone to move due the effects of gravity on the ornamental connector 1000.

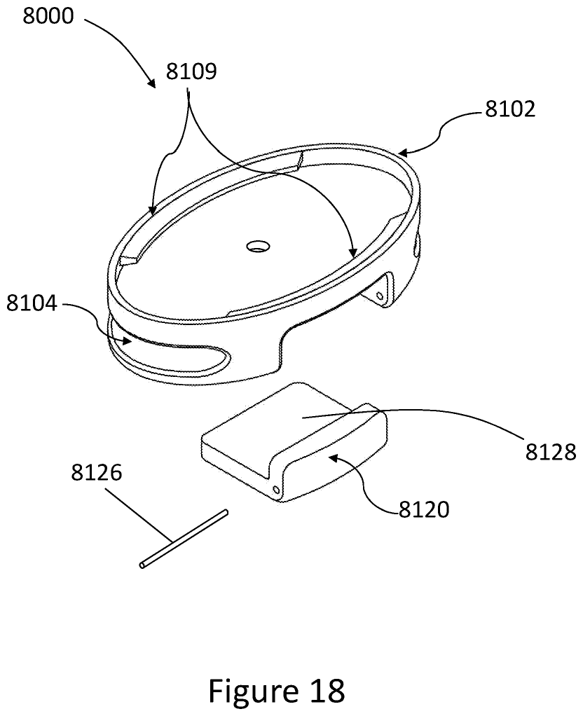

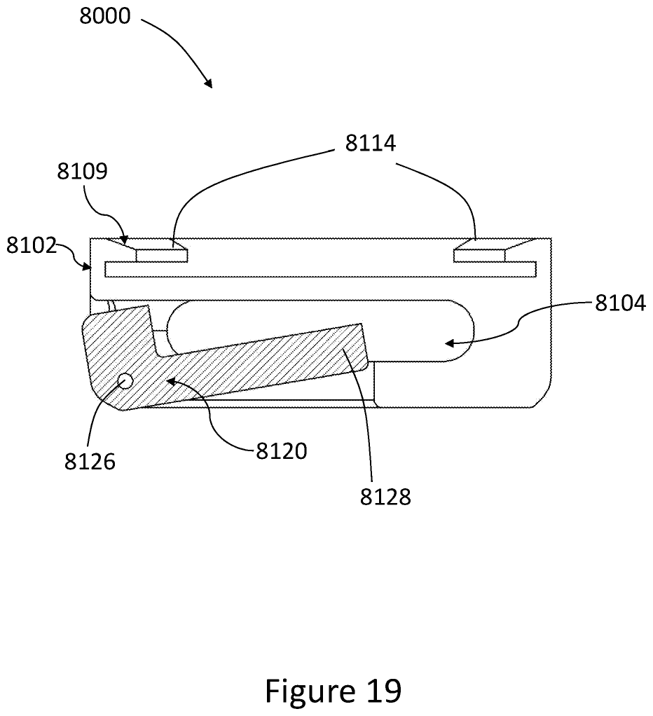

The holding arrangement 1120 is similar to the holding arrangement of the embodiment of an ornamental connector shown in FIGS. 18 and 19, and will be described in more detail below.

In the first embodiment shown in FIGS. 1-7, the base 1102 is permanently connected to, and preferably integrally formed with the engaging arrangement 1109. The engaging arrangement includes engaging formations 1110 in the form of arms extending from the base 1102. The engaging formations 1110 are resiliently deformable. When in use, the ornamental item 1100 may be attached to the engaging arrangement 1109 by applying force to the ornamental item 100 while holding the engaging arrangement 1109 or alternatively the base 1102. The application of force on the ornamental item 1100 causes the engaging formations 1110 to deform allowing for the ornamental item 1100 to be inserted underneath engaging formations 1110 to securely attach to the engaging arrangement 1109.

The ornamental item 1100 may be made from a number of preferably aesthetically pleasing materials ranging from precious stones to polished metals or decorative polymer materials. It will be appreciated by a person skilled in the art, that when precious stones are used for the ornamental item 100, that due to its weight and value it is of importance that it be securely attached to the base. This is achieved using the engaging formations 1110 which have the ability to flex while applying sufficient force to the ornamental item to keep the ornamental item 1100 securely attached to the engaging arrangement 1109.

In order to remove the ornamental item 100 from the engaging arrangement 109 an opposite force to that which was applied to insert the ornamental item 100 into the engaging arrangement 109 is applied, causing the engaging formations 110 to deform under load allowing for the removal of the ornamental item 100 from the engaging arrangement 109.

The base 102 may take a number of different shapes, however it is preferable that the base 102 has rounded corners and generally smooth edges so as to prevent the base 102 catching on clothing and the like which may occur if the base 102 were to be comprised of sharp edges or the like.

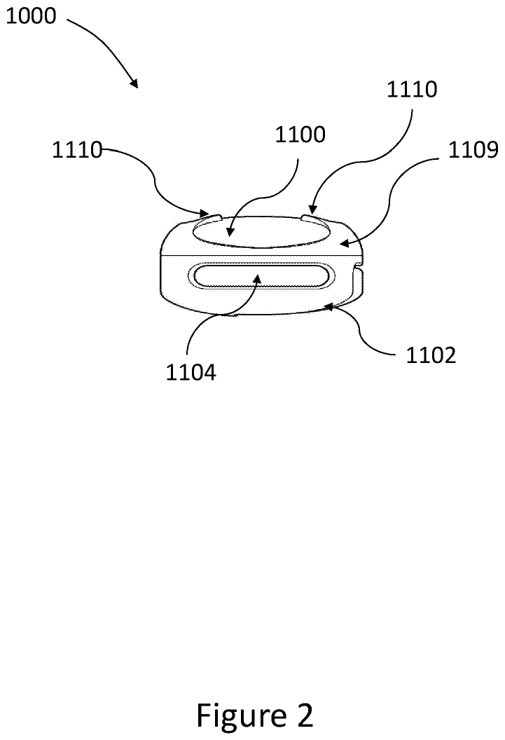

Referring to FIGS. 1 and 2, a single aperture 1104 is provided which is located in and extends through the base 1102. In alternative embodiments (not shown), a plurality of apertures may be provided. The aperture 1104 is preferably sized such that it can fit a variety of different sized elongate flexible members 10, ranging from belt buckles, bikini straps, chains and other articles of clothing that are elongate in shape.

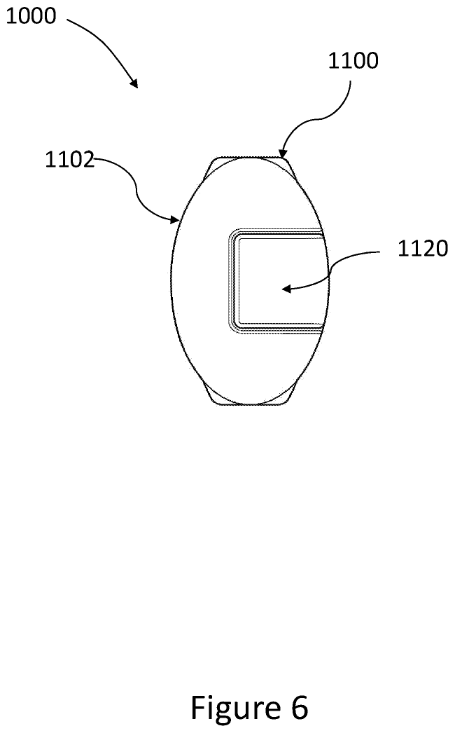

As discussed previously, the aperture 1104 may include a holding arrangement 1120 which is adapted to restrict the movement of an elongate member 10 when in use. FIG. 6 shows the location of the holding arrangement 1120 on a lower face of the ornamental item 100 where it is envisaged that the operator would apply finger pressure to the holding arrangement 1120 and apply forward or backward force depending on whether the operator is engaging or disengaging the holding arrangement 1120.

As an example, when a user is inserting the elongate flexible member 10 into the aperture 1104 the user would disengage the holding arrangement 1120 in order to aid in the insertion of the elongate flexible member 10 into the aperture 1104. Once the ornamental connector 1000 has been positioned at its desired position, the user would then move the holding arrangement 1120 into the engaging position in order to lock the ornamental item 1100 into place on the elongate flexible member 10 preventing it from sliding along the elongate flexible member 10 when in use.

The base 1102 and the engaging arrangement 1109 may be constructed from a variety of different materials ranging from polymers to metallic materials such as aluminium or any other decorative material. It is preferable that the materials used in the construction of the ornamental connector 1000 be resistant to corrosion as the ornamental connector 1000 is likely to be exposed to moisture either in the washing machine or if worn at the beach as examples.

It will be appreciated that the engaging arrangement 1109 needs to be constructed from a resilient material with particular emphasis on the engaging formations 1110 which need to elastically deform to allow for the insertion and removal of the ornamental item 100 as was discussed previously.

The base 1102 and engaging arrangement 1109 can be made out of a buoyant material such that it will float if dropped into water. This is particularly important where the ornamental connector 1000 is worn at the beach or near a swimming pool.

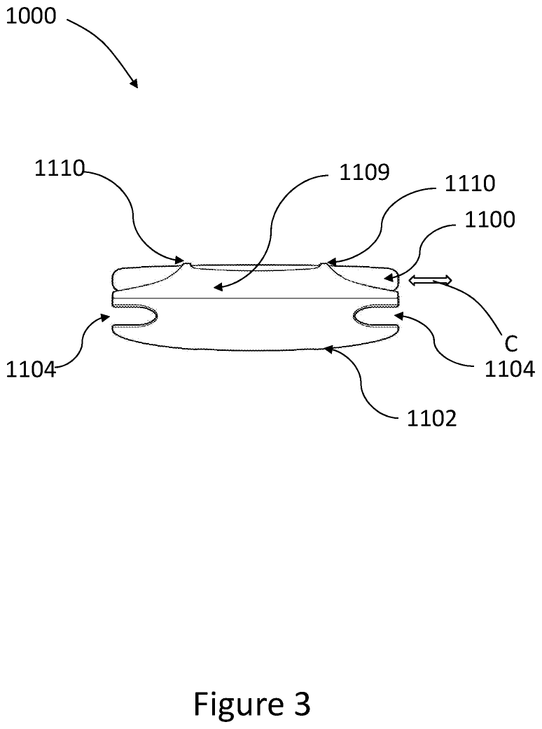

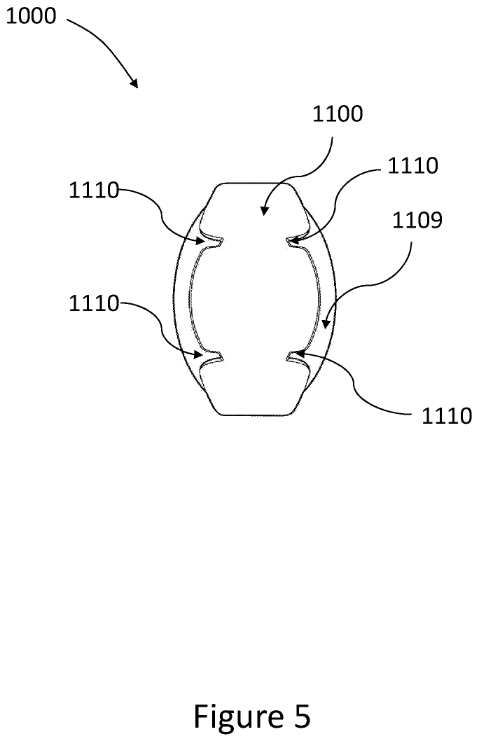

In the embodiment shown in FIG. 5, the engaging arrangement 1109 is more clearly shown and consists of engaging formations 1110 which are constructed from a resilient material such as a flexible plastic or rubber material that is able to deform when an ornamental item 1100 is inserted into the engaging arrangement 1109. In this embodiment, it is envisaged that the ornamental item 1100 will be inserted into the engaging arrangement 109 in a direction as shown by arrow C in FIG. 3. In the embodiment shown in FIGS. 1-7, the engaging formations 110 can flex back and forth when the ornamental item 100 is either attached or removed from the engaging arrangement 109. In this embodiment, the base 1102 is permanently attached to the engaging arrangement 1109.

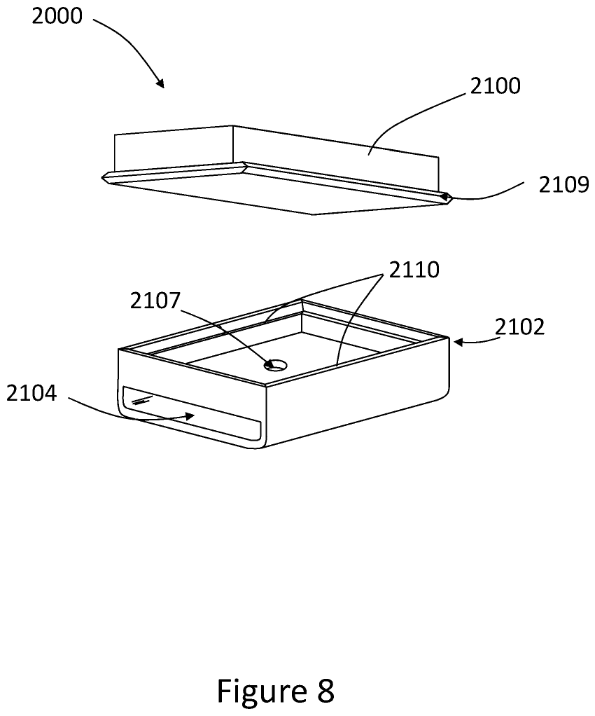

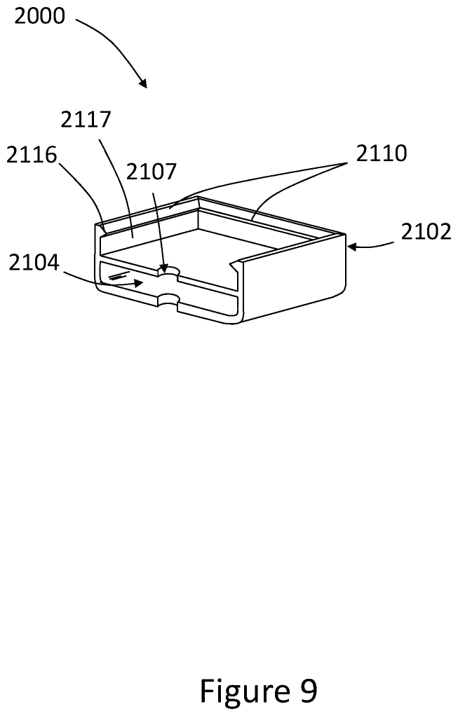

A further embodiment of an ornamental connector 2000 is shown in FIGS. 8 and 9. In this embodiment the engaging formations 2110 extend substantially around the periphery of base 2102, allowing for the secure attachment of the ornamental item 2100. The engaging formations extend over a peripheral perimeter length that allows for secure attachment of the ornamental item 2100. The engaging arrangement 2109 is permanently secured to, and preferably integrally formed with, the base 2102 of the ornamental connector 1000. The engaging formations 2110 include snap fit formations 2112 that are resiliently deformable to snap into place after receiving the ornamental item 2100, thereby preventing movement of the ornamental item 2100 in any direction. The snap fit formations 2112 include barb formations 2116 located at the distal upper edge of walls 2117.

In the embodiment as shown in FIGS. 8 and 9, the ornamental item 2100 is engaged with the base 2102 by pushing the ornamental item 2100 downwardly onto the engaging formations 2110, causing them to elastically deform, until the ornamental item 2100 is seated on the base 2102, wherein the engaging formations 2110 will at least partially enclose the ornamental item 2100 to retain it in position. The ornamental item is provided with complementary securing formations 2122 for securely engaging with the engaging formations 2110.

As can be seen in FIGS. 8 and 9, to aid in the removal of the ornamental item 2100 from the base 2102, a cavity 2107 in the form of a hole extending through the base 2102 is included in the base 2102 of the ornamental connector 1000. In this case, the removal of the ornamental item 2100 may be achieved by inserting an elongated member (not shown) into the cavity 2107 from underneath the base 2102 in order to apply force to the underside of the ornamental item 2100 with sufficient force to cause the engaging formations 2110 to deform allowing the ornamental item 2100 to detach from the base 2102. This would preferably need to be carried out when the elongate flexible member 10 is removed in order to reveal the cavity 2107.

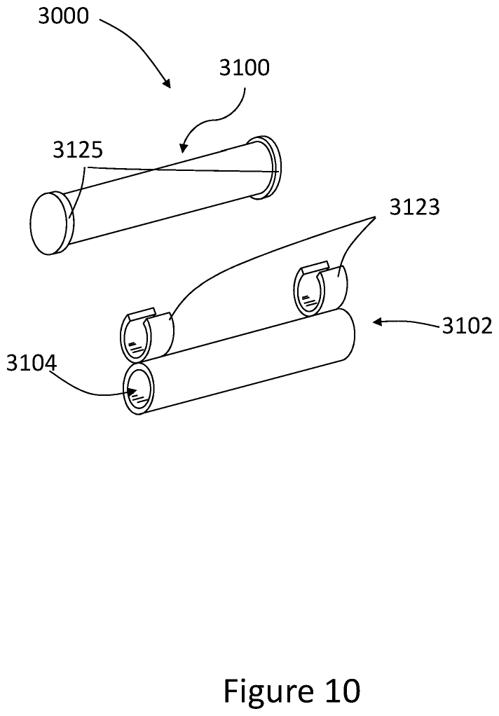

A further embodiment is shown in FIG. 10, wherein the engaging formation includes resiliently flexible semicircular arms 3114 that elastically deform to receive a complementarily shaped cylindrical ornamental item 3100. The ornamental item 3100 includes securing formations 3122 in the form of flanges 3116 at each end, the flanges 3116 serving to prevent sliding longitudinal movement of the ornamental item 3100 out of the semicircular arms 3114.

In an alternative embodiment (not shown), it is envisaged that the base 3102 could include securing formations instead of the ornamental item. In another embodiment (not shown), the engaging arrangement may include at least one pair of opposed engaging formations for attachment of the ornamental item to the base, in order to prevent the ornamental item from slipping out of the base when in use, flange formations may be used to reduce lateral movement of the ornamental item.

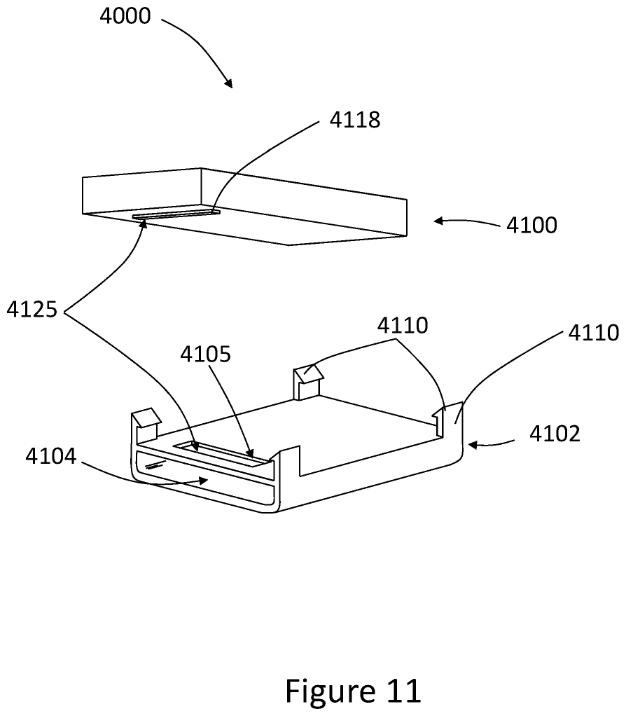

In a further embodiment shown in FIG. 11, the ornamental item 4100 is releasably attachable to the base 4102. The base includes engaging formations 4110 in the form of barbed arms 4112 that are resiliently and elastically deformable. In the embodiment shown in FIG. 11, the ornamental item 4100 is prevented from slidably detaching from the base 102 by the provision of a locating structure 4125. The locating structure 4125 includes a protrusion 4118 that is engageable in a complementarily shaped recess in the which prevents lateral movement of the ornamental item 4100 in relation to the base 4102, while twisting movement of the ornamental item 4100 is prevented by barbed arms 4112.

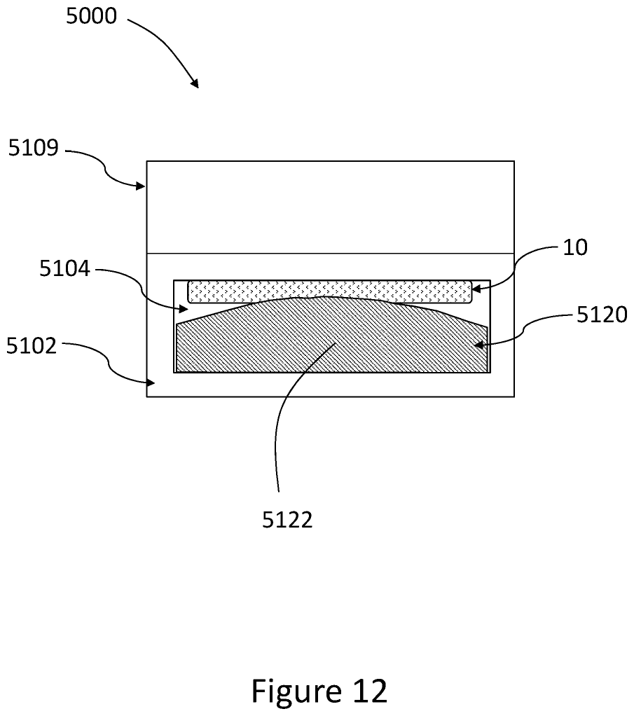

It is envisaged that an ornamental connector could include a holding arrangement for ensuring that the ornamental connector does not slide along the elongate member 10. Such a holding arrangement could be of a wide range of shapes and configurations, and operate on a wide range of principles. Various embodiments of a holding arrangement are shown in FIGS. 12-19.

In the embodiment shown in FIG. 12, the holding arrangement 5120 includes a resilient member 5122 that is preferably composed of a resilient plastic and/or polymer such as silicone, polyethylene, polypropylene, or the like. The resilient member 5122 is located within the aperture 5104 in the base 5102. In use. elongate flexible member 10 is pushed through the aperture 5104, elastically displacing the resilient member 5122. The holding arrangement 5120 will apply a force to the flexible elongate member 10, restricting movement of the ornamental connector 5000 along the elongate flexible member 10 in use.

As shown in FIG. 12, the holding arrangement 5120 may take the form of a resilient device such as a spring or plastic or rubber resilient member 5122 and is positioned within the aperture 5104 so as to reduce the size of the aperture 5104 once the elongate flexible member 10 has been inserted into the aperture 5104. It is envisaged that the resilient plastic member will generate friction to prevent movement of the flexible elongate member 10 through the aperture 5104.

FIG. 12 exemplifies the use of the holding arrangement 5120 in situ within the aperture 5104 to hold the elongate flexible member 10 in position and reduce its movement by the use of friction. In the embodiment shown, the holding arrangement 5120 is permanently inserted into the aperture 5104 and provides sufficient resistance to the movement of the elongate flexible member 10. However, the holding arrangement 5120 is sized such that it provides enough clearance to allow for the elongate flexible holding member 10 to be inserted into the aperture 5104 without undue force. The holding arrangement 5120 may be made from a resilient elastically deformable material such as a soft rubber, a resilient plastic or a resilient foam material.

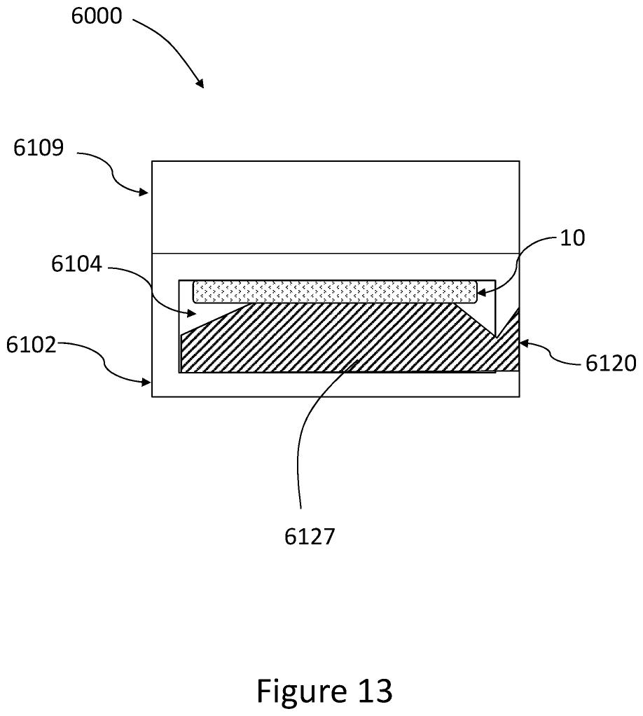

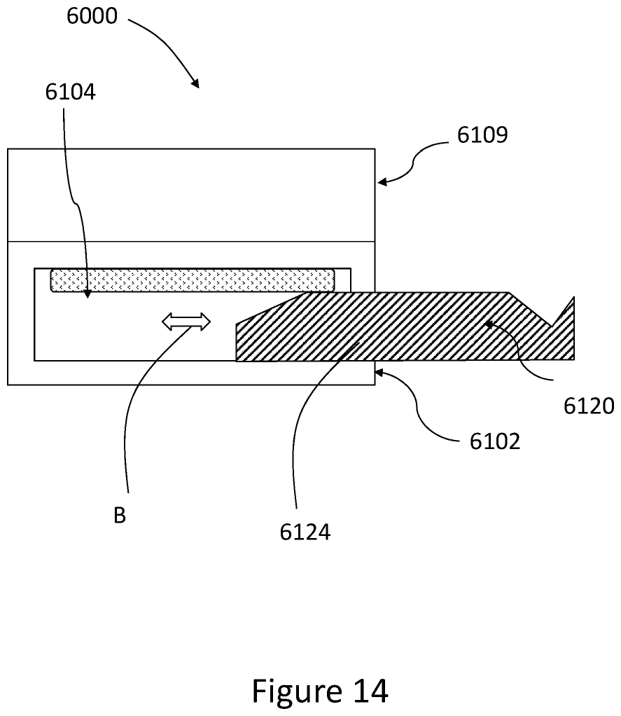

In the embodiments shown in FIGS. 13 and 14, an ornamental connector 6000 is provided in which the holding arrangement 6120 is slidingly movable between an engaged position (shown in FIG. 13) and a disengaged or disengageable position (shown in FIG. 14). The holding arrangement 6120 includes a sliding member 6127 that is slideable in a direction laterally across the length of the elongate flexible member 10, preferably on a track (not shown) set into the base 6102. Preferably the sliding member is also composed of a friction generating resilient material such as a plastic, rubber or silicone, and can include a rigid portion (not shown) and a softer portion, preferably integrally formed with each other in a moulding process. When the holding arrangement 6102 is in its disengageable position, the elongate flexible member 10 may be more readily inserted into the aperture 6104, and when the holding arrangement 6120 in its engaged position, the sliding member 6127 at least partially blocks the aperture 6104, causing the elongate flexible member to be more restricted in its movement through the aperture 6104.

In FIGS. 13 and 14, an embodiment of a holding arrangement 6120 is shown that includes a sliding resilient plastic member 6127 that is slidingly moveable between its engaged position and its disengageable position in the direction shown by arrow B in FIG. 14.

Preferably, the holding arrangement 6120 may be adjusted between its engaged position and its disengageable position by application of force by a person's hand on the sliding member 6127 of the holding arrangement 6120.

In the embodiment shown in FIGS. 13 and 14, the holding arrangement 6120 also acts as a wedging arrangement that is adapted to compress the elongate flexible member 10 in use. It is envisaged that the wedging arrangement can include a wedge formation that can be inserted from a disengageable position into the aperture preferably on a track. The wedge formation is adapted to compress the flexible elongate member against the base in an engaged position as it is inserted, thereby restricting movement of the elongate flexible member relative to the ornamental connector in use. The holding arrangement 6120 can include a snap fit formation (not shown) to keep the wedging arrangement in place

FIG. 13 exemplifies a further embodiment in which the holding arrangement 6120 is slidably removable from the base 6102, where in FIG. 14 the holding arrangement is shown removed from the base 6102.

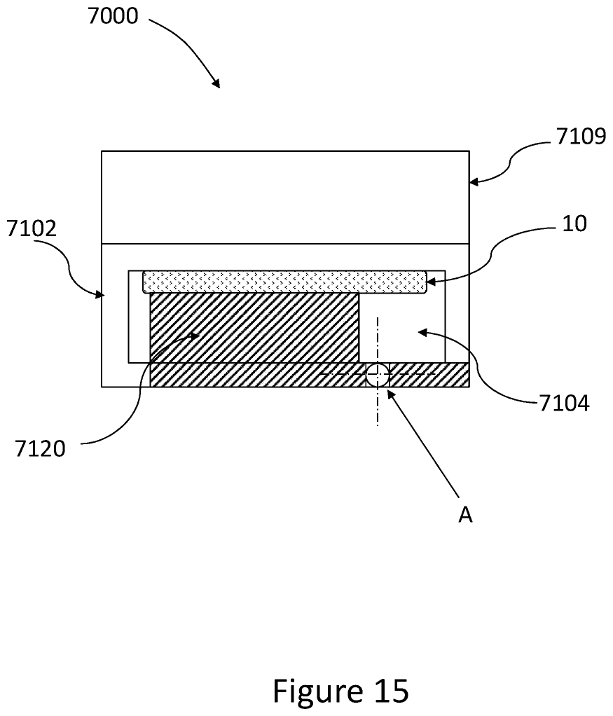

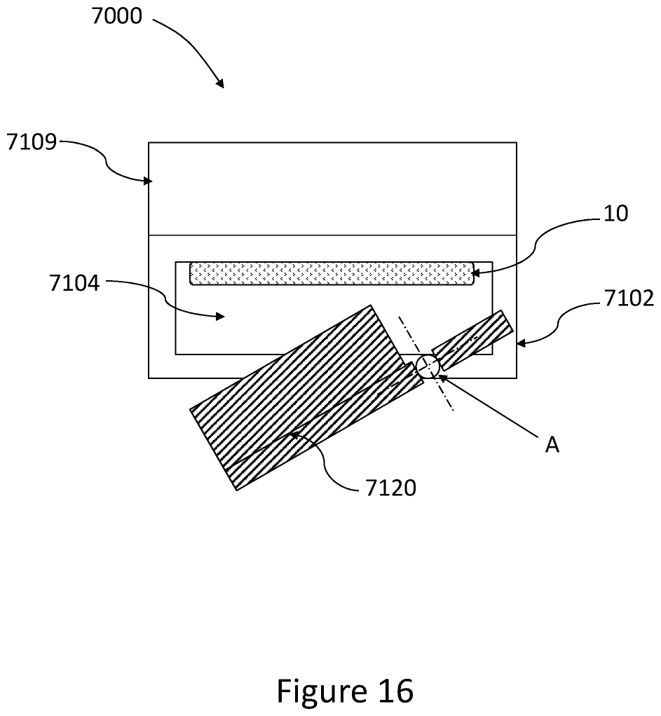

In another embodiment as shown in FIGS. 15-16, the holding arrangement 7120 includes a pivoting member 7128 that is pivotably moveable between its engaged position and its disengageable position, and a biasing mechanism (not shown). The pivoting member 7128 is pivotable about pivot axis A. The biasing mechanism preferably includes a resilient member in the form of a spring, such as a coil spring or a leaf spring (not shown). The pivoting member 7128 is preferably manually movable between an engaged position and a disengageable position. The pivoting movement of the pivoting member 7128 is preferably biased to the engaged position.

In the disengageable position, the flexible elongate member can be extended through the aperture 104, and in the engaged position in use, the pivoting member 7128 clamps onto the elongate flexible member 10, thereby restricting movement of the elongate flexible member 10 relative to the ornamental connector 1000.

As is exemplified in the figures, and as described above, the aperture in the base is configured such that the elongate flexible member 10 may be readily threaded through the aperture to allow for secure attachment to an item of clothing or more generally a person's body.

In another embodiment as will be described below the ornamental item may be permanently attached to the engaging arrangement and the engaging arrangement may be removably detachable from the base.

In another embodiment, the engaging formations may be constructed of a resilient material such as a resilient metal like spring steel or plastic material which is able to alter its position on the application of force from the ornamental item when it is inserted into the engaging arrangement.

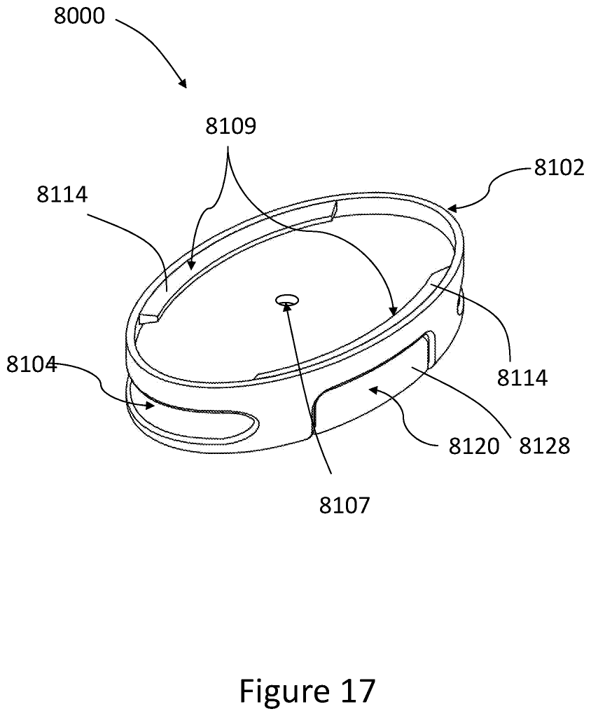

In FIGS. 17-19, another embodiment of an ornamental connector 8000 is shown. In this embodiment the base 8102 and engaging arrangement 8109 are permanently connected to each other. The engaging arrangement 8109 is in the form of an ellipsoid flange extending outwardly from the base, and from which two resilient lips 8114 extend inwardly. The two resilient lips 8114 extend partly around the periphery of the base. The ornamental item 8100 can be press fitted past the two resilient lips 8114 to engage with the base 8102, in a manner similar to the embodiment shown in FIGS. 8 and 9.

The embodiment shown in FIGS. 17-19 also includes a pivoting holding arrangement 8120 similar to that shown in FIGS. 15 and 16. The pivoting holding arrangement 8120 includes a pivoting member 8128 that is pivotably movable about a pivot pin 8126 between an engaged position (shown in FIG. 19) and a disengageable position. The pivoting member 8128 is biased by a spring arrangement (not shown) towards its engaged position to clamp onto an elongate flexible member 10 in use to prevent movement of the ornamental connector 8000 along the elongate flexible member 10.

FIG. 18 shows an exploded view of the embodiment of FIG. 17, showing the holding arrangement 8120 in the form of a pivoting member 8128 that is pivotably moveable around a pin 8126 as a hinge structure. The pivoting member is preferably biased to its engaging position by a spring (not shown).

FIG. 19 shows the embodiment of FIGS. 17 and 18 in cross section with the holding arrangement 8120 in its engaged position. In this embodiment, the holding arrangement 8120 is biased using a resilient member (not shown) in the form of a spring, resilient polymer or rubber as some examples. The holding arrangement 8120 is preferably biased in a closed position or engaged position.

In further embodiments which will be described below, the engaging arrangement may be detachable from the base, allowing for different engaging arrangements to be attached to the base. The engaging arrangement may be detachable from the base through the use of snap-fit plastic joints constructed from a resilient plastic allowing for the attachment and the release of the engaging arrangement from the base by applying force between the engaging arrangement and the base.

Another means of attaching the engaging arrangement to the base may be by the use of insertable members which could be adapted to engage with complementary mating members. Alternatively, the engaging arrangement may be attached to the base using a semi-permanent means such as screws of other attachment means. The base and engaging arrangement may alternatively be attached using a permanent means such as an adhesive.

The ability of the base to be detachable from the engaging arrangement may be preferable where a user would like to use a different style of engaging arrangement for aesthetic purposes or in order to fit different size or shape ornamental items to the engaging arrangement. Such functionality will be described below with reference to alternative embodiments.

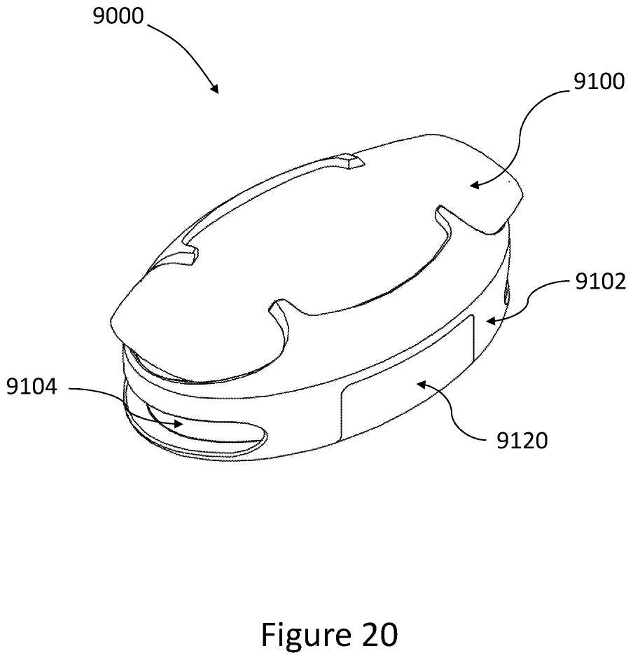

FIGS. 20-22 show a further embodiment of an ornamental connector 9000 in which the ornamental item 9100 is removably attachable to the base by a removable engaging arrangement 9109. In this embodiment, the ornamental item 9100 is permanently secured to a removable portion 9113 of the engaging arrangement 9109 (although in alternative embodiments it may be removable similar to the embodiment shown in FIG. 1). The removable portion 9113 of the engaging arrangement 9109 includes a T-shaped protrusion 9132 extending from the engaging arrangement 9109. The removable portion 9113 is engageable with the base 9102 as will be described below.

In ornamental connector 9000 shown in FIGS. 20-22, the base 9102 is connected to the engaging arrangement 9109 in a releasable manner. When the base 9102 is releasably attached to the engaging arrangement 9109 the appearance of the ornamental connector 9000 can be altered without the need for replacing the entire ornamental connector 9000 in order to substantially change its appearance. As previously discussed, the engaging formations 9110 are preferably adapted to securely receive the ornamental item 9100 in a removable fashion.

In FIG. 20 the ornamental connector 1000 is shown in its assembled form showing the assembled relationship between the ornamental item 9100, the base 9102 the holding arrangement 9120 and the aperture 9104.

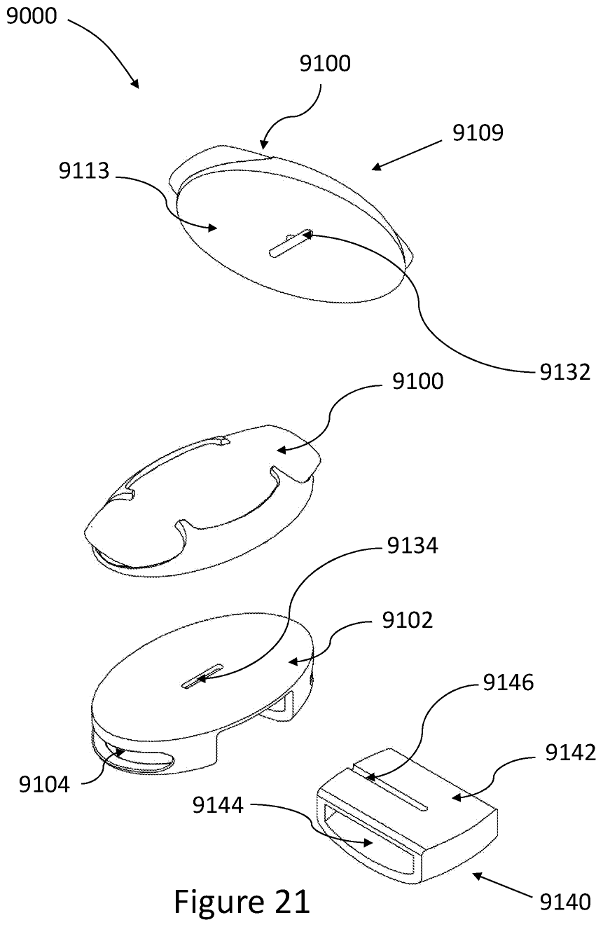

In FIG. 21, the ornamental connector 9000 is shown in exploded perspective view. As may be seen from FIG. 21, the engaging arrangement 9109 comprises a T-shaped protrusion 9132 which may take the form of a head and neck configuration. The T-shaped protrusion 9132 is adapted to be inserted into a complementary shaped engaging slot 9134 in the base 9102.

The insertion of the T-shaped protrusion 9132 into the engaging slot 9134 is achieved by orientating the ornamental item 9100 at 90 degrees to the base 9102 to align the T-shaped protrusion 9132 with the engaging slot 9134, which is complementary in shape to the T-shaped protrusion. Once alignment has been achieved the T-shaped protrusion 9132 is inserted into the engaging slot 9134 by a downward motion to move the removable portion 9113 towards the base 9102, to thereby allow the T-shaped protrusion 9132 to be received within the engaging slot 9134, allowing them to be mated together.

Once the T-shaped protrusion 9132 has been inserted into the engaging slot 9134 the ornamental item 9100 is then rotated in relation to the base 9102 until the profile of the removable portion 9113 and the base 9102 are aligned at which point secure engagement is achieved. Movement of the removable portion 9113 away from the base 9102 will result in the T-shaped protrusion 9132 abutting against the base to prevent the withdrawal of the T-shaped protrusion 9132. In order to ensure that the ornamental item 9100 does not rotate in relation to the base 9102 and become detached, a locking arrangement 9140 is provided as will be described next.

As shown in FIG. 21, a locking arrangement 140 is used to ensure the ornamental item 9100 does not rotate in relation to the base 102 when the locking arrangement 9140 is inserted into the base 9102, preventing the detachment of the ornamental item 9100 from the base 9102.

The locking arrangement 140 comprises a locking member 9142. The locking member 9142 includes a base in which an aperture 9144 is defined. The locking member 9142 is configured to be moved from an unlocked condition in which the locking member 9142 is removed from the base, to a locking condition in which the locking member 9142 is slidably received into a recess in the base 9102, preferably on a track arrangement (not shown). When the locking member 9142 is received into the base 9102 in its locked condition, the aperture 9144 of the locking member 9142 and the aperture 9104 of the base 9102 are preferably in alignment.

The aperture 9144 in the base of the locking member 9142 is configured for receiving the elongate flexible member 10 after the locking member 9142 is inserted into the base 9102. The locking member 9142 further includes a locking slot 9146 which extends around and receives the T-shaped protrusion 9132 as the locking member 9142 is moved from its unlocked condition to its locked condition. In this way, the orientation of the T-shaped protrusion 9132 is secured or locked, preventing withdrawal of the T-shaped protrusion 1132 when the locking member 9142 is in its locked condition. It is envisaged that the locking arrangement 9140 may also include a track (not shown) to guide the locking arrangement into the base 9102 and a snap fit formation (not shown) to keep the locking arrangement in position inside the base 9102, and aligned with the sides of the base 9102. In use, it is envisaged that the flexible elongate member 10 will extend to both the aperture 9104 in the base 9102 as well as the aperture 9144 in the locking member 9142, thereby preventing removal of the locking member 9142 from the base 9102. It is further envisaged that either of the base 9102 and the locking member 9142 may be provided with a holding arrangement as shown in any of the embodiments, in order to prevent movement of the ornamental connector 9000 along the length of the flexible elongate member 10. In this way, if, for example the straps of a swimsuit are undone, the ornamental connector 9000 will remain in position on the strap, preventing it from being lost. Further, while the straps are tied, and the flexible elongate member 10 extends through apertures 1144, 9104 the removable portion 1113 cannot be removed from the base 9102.

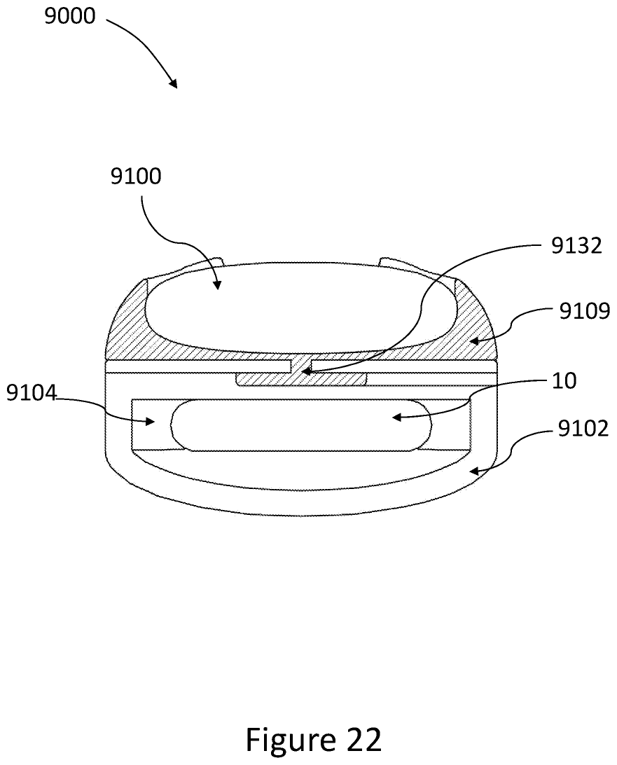

FIG. 22 shows the removable portion 9113 of the engaging arrangement 9109 securely fixed to the base 9102. When in use, the elongate flexible member 10 is threaded through the aperture 9104 of the base 9102 and through the aperture of the locking arrangement 9144 preventing the removal of the locking member 9142 when the elongate flexible member 10 is inserted into the aperture 9104 and the aperture of the locking member 9144.

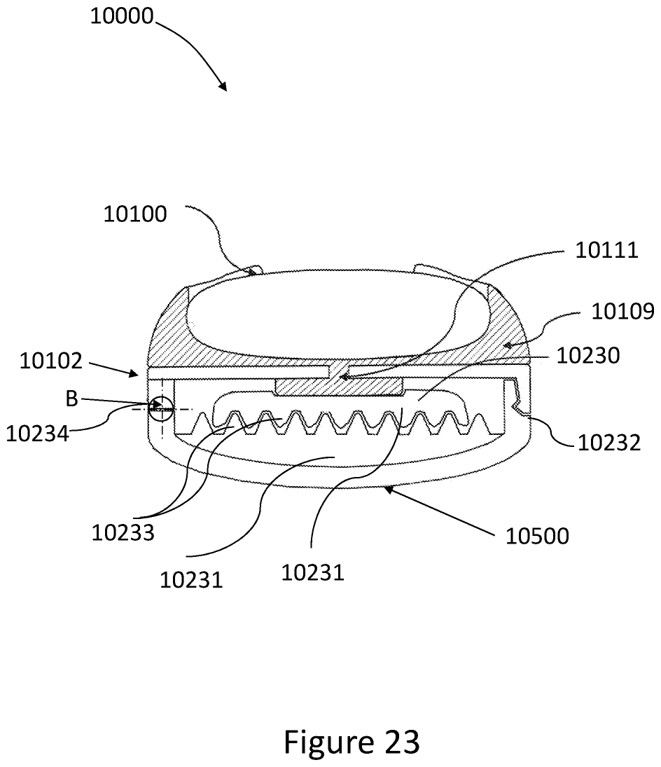

In FIG. 23 a further embodiment of an ornamental connector 10000 is shown in which the elongate flexible member (not shown) may be inserted from the side of the ornamental connector 10,000 rather than being threaded through the aperture 10104 as was necessary in the previous embodiments.

In the embodiment of FIG. 23, the engaging arrangement 10109 is fixed to the base 10102 via a T-shaped protrusion 10111 (similar to that shown in FIGS. 20-22) that is connected to a locking arrangement 10230 that is moveable between a locked condition as is shown in FIG. 23 and an unlocked position (not shown).

The locking arrangement 10230 includes a closure member 10500 that is pivotable via a hinge structure 10234 about a pivoting axis (shown as arrow B in FIG. 23) between an open position and a closed position. In its closed position, the closure member 10500 can be engaged with base 10102 by a clip or clipping arrangement 10232. When the closure member 10500 is in its open position, this corresponds with the unlocked condition of the locking arrangement 10230. When the closure member 10500 is in its closed position, this corresponds with the locked condition of the locking arrangement 10,230.

As is shown FIG. 23, the locking arrangement 10230 comprises a pair of preferably resilient locking bodies 10231. Each of the locking bodies 10231 include interdigitated formations or teeth 10,233 which are configured to interlock with each other when the locking arrangement 10230 is in its locked condition, to thereby prevent the rotation of the T-shaped protrusion 10111 and hence the detachment of the ornamental item 10100 from the base 10102. It is envisaged that the elongate flexible member will be clamped between the interdigitated formations 10233 when the locking arrangement 10230 is in its locked condition.

In the embodiment shown in FIG. 23, an elongate flexible member (not shown) is attached to the ornamental connector 1000 by the arrangement of a closure member 10500 and a clip 10232. The clip 10232 is located opposite a hinge structure 10234, allowing the closure member 10500 to be moved between an open position and a closed position.

The hinge structure 10234 may comprise a conventional hinge or a resilient member and which is adapted to allow for an elongate flexible member (not shown) to be inserted from the side of the ornamental connector 1000, once inserted a closure member 500 is moved into its closed position in which case the clip 232 is closed and the elongate flexible member (not shown) is then fixed between the interdigitated formations 10233 of the locking arrangement 10230 preventing the rotation of the T-shaped protrusion 10111 and securing the elongate flexible member between the interdigitated formations whilst ensuring secure attachment of the ornamental item 10100 to the base 10102.

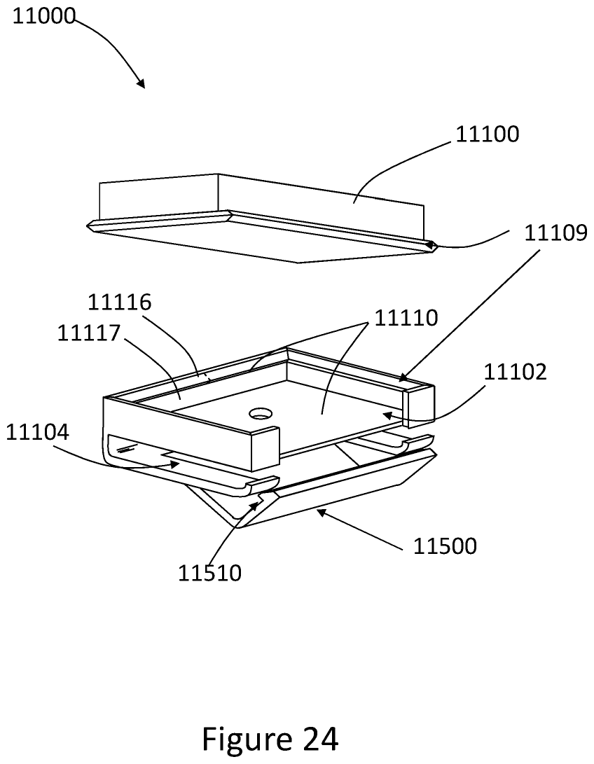

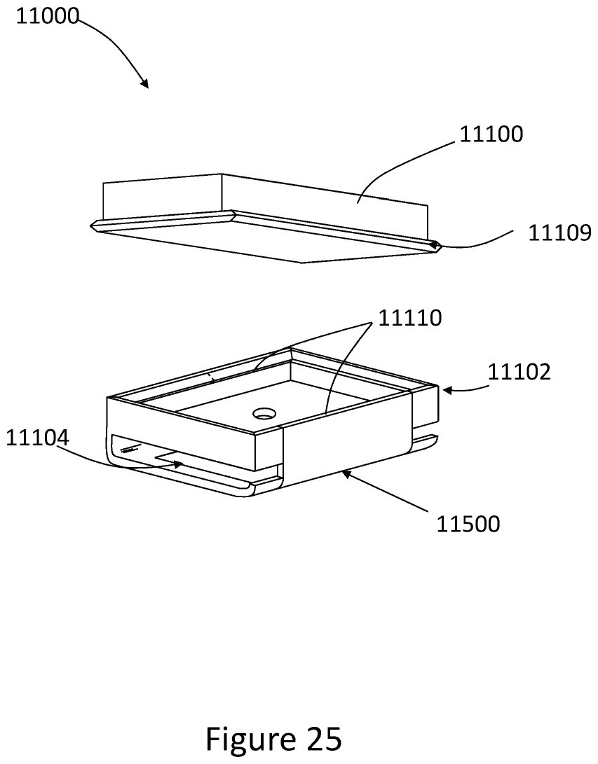

FIGS. 24 and 25 show a further embodiment of an ornamental connector 11000 where an elongate flexible member is insertable from the side of the ornamental connector 1000 into an aperture 11104 rather than being threaded through the aperture 11104 as shown in previous embodiments. As shown in FIGS. 24 and 25, the ornamental connector includes a pivoting closure member 11500 movable about a hinge (not shown) between an open position and a closed position. The engaging arrangement 11109 of ornamental connector 11000 includes engaging formations 11110 in the form of a plurality of walls 11117 extending around the periphery of the base 11102, the walls 11117 including barb formations 11116 extending inwardly. Closure member 11500 also includes a barb formation 11510 extending along its distal edge, the barb formation 11510 being similar to barb formations 11116 of the engaging arrangement 11109. When the closure member 11500 moves to its closed position, the barb formation 11510 moves into alignment with barb formations 11116. It is envisaged that the ornamental item 11100 configured for engagement with the engaging arrangement will be similar to the ornamental item shown in FIGS. 8 and 9. Engagement of the ornamental item with the engaging arrangement 11109 will also serve to lock the closure member 11500 in its closed position.

The elongate flexible member (not shown) may be inserted from the side when a closure member 11500 is in the open position as shown in FIG. 24, after which the closure member 500 may be moved into its closed position as exemplified in FIG. 25, and the ornamental item engaged with the engaging arrangement (and the barb formations 11510 of the closure member 11500) to secure the elongate flexible member into place.

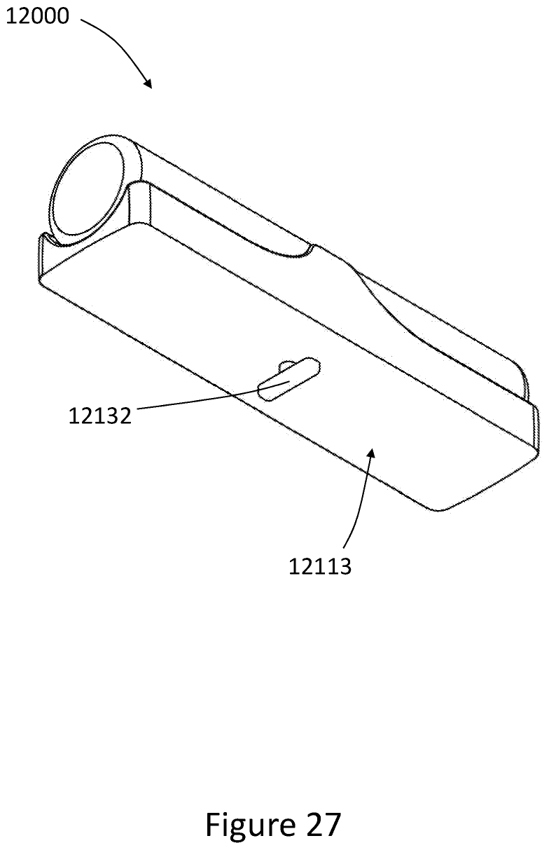

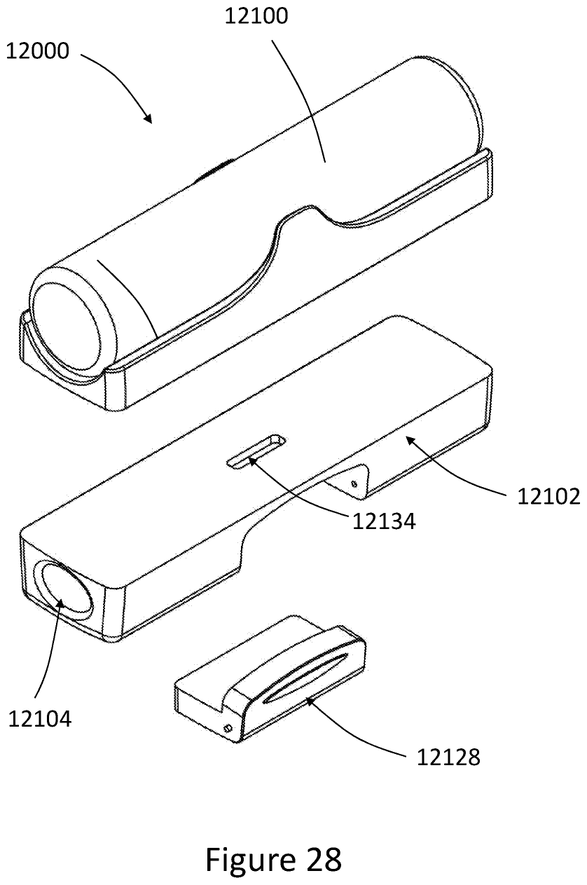

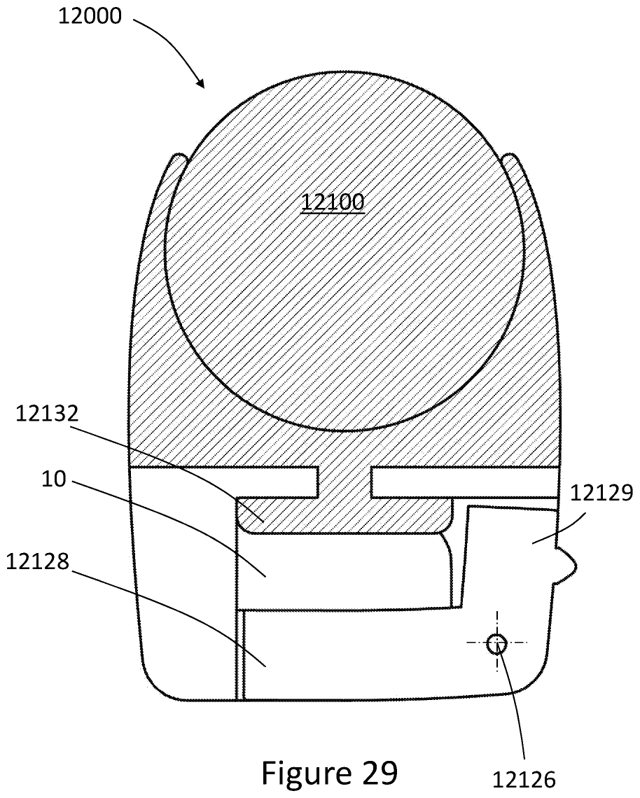

In a further embodiment of an ornamental connector 12000 shown in FIGS. 27-30, the ornamental item 12100 is permanently affixed to removable portion 12113 of engaging arrangement 12109. A T-shaped protrusion 12132 is provided that extends at right angles to the direction of alignment of the elongate flexible member. The T-shaped protrusion 12132 is configured for being inserted into a complementarily shaped engaging slot 12134 similar to the embodiment shown in FIG. 21, and then pivoted to engage the T-shaped protrusion with the base to prevent removal of the T-shaped protrusion from the slot.

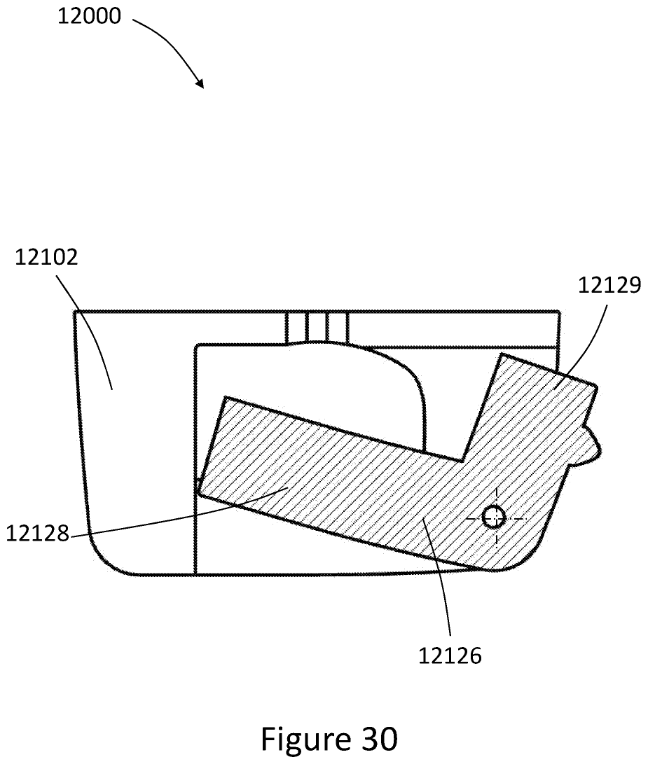

As shown in FIG. 27-30, the ornamental item 12000 includes a holding arrangement 12120 that also operates as a locking arrangement. The holding arrangement 12120 includes a pivoting member 12128 similar to that shown in FIGS. 17-19, that is pivotable about a pivot pin 12126. A pivoting member 12128 is movable between an engaged position (shown in FIG. 30) and a disengageable position, and is biased to its engaged position. In this embodiment, removable portion 12113 is engaged with base 12102, and twisted 90 degrees. Then the pivoting member 12128 is held in its disengageable position by pushing on the shorter lever arm 12129 of pivoting member 12128, after which the elongate flexible member 10 is inserted through aperture 12104 in base 12102. On releasing pivoting member 12,128, the pivoting member will be biased to its engaged position to push the elongate flexible member 10 up against the T-shaped protrusion 12,132, restricting movement of the T-shaped protrusion.

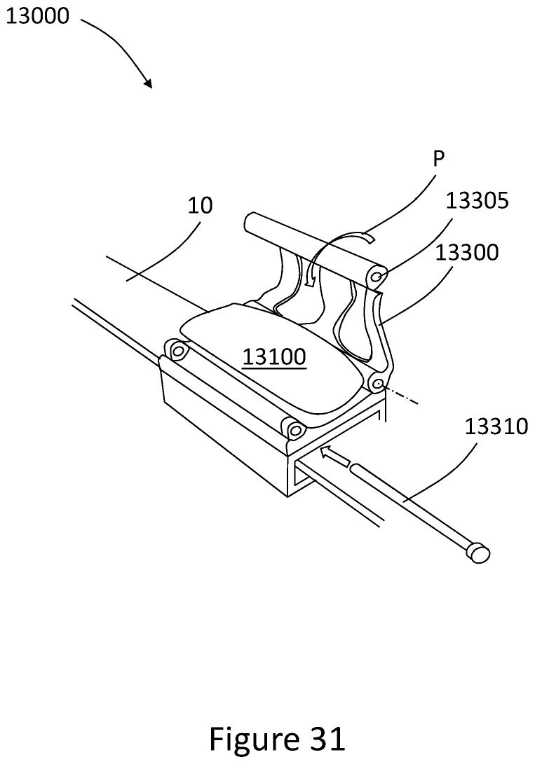

A further embodiment of an ornamental connector 13,000 is shown in FIG. 31. In this embodiment, the engaging arrangement 13109 includes a pivoting member 13300 that is pivotably movable between a removable condition and an engaging condition as shown by arrow P in FIG. 31. The pivoting member 13300 is configured to extend over the top of ornamental item 13100, to engage with the ornamental item and hold it securely in position in use. Pivoting member 13300 includes engaging formations in the form of an aperture or bore 13,305 through which a locking pin 13310 is receivable. The bore 13305 aligns with preferably similarly sized apertures in the base when the pivoting member 13300 is in its engaging condition. Locking pin 13310 is preferably held in position by a circlip or similar (not shown).

In order to change the ornamental item 13100, the circlip is first removed, after which the locking pin 13310 is removed from bore 13305 and the pivoting member 13300 is pivotably moved to its removable condition. The ornamental item 13300 can then be replaced and the above process reversed.

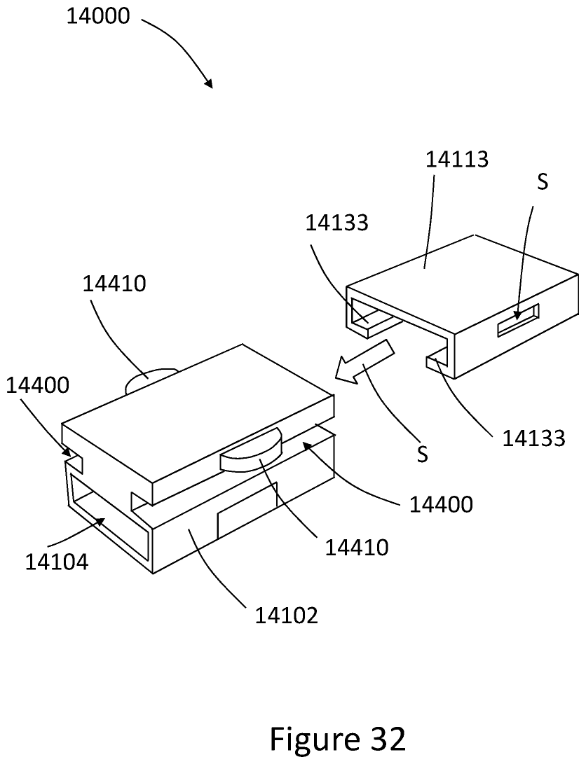

A further embodiment of an ornamental connector 14000 is shown in FIG. 32, without an ornamental item attached for the sake of clarity. In this embodiment, the engaging arrangement also includes a removable portion 14113 that is preferably permanently secured to an ornamental item. The removable portion 14113 is U-shaped in cross-section, and includes inwardly extending lips 14133. The base 14102 includes aperture 14104, as well as a pair of channels 14400 that are configured to complement the configuration of the inwardly extending lips 14133. The removable portion 14113 is slidable in a direction shown as arrow S in FIG. 32 over the base 14102, with the inwardly extending lips 14133 engaging within the opposed channels 14400. The base 14102 further includes a pair of opposed locating lugs 14410 extending from opposed sides of the base 14102. The opposed locating lugs 14410 are preferably biased by an internal biasing mechanism (not shown) that buyers the opposed locating lugs to extend outwardly from base 14102. The opposed locating lugs 14410 are configured for extending into and locating snugly with locating slots 14135 in removable portion 14113. The internal biasing mechanism will be apparent to person skilled in the art, and a discussion of its inner workings is considered beyond the scope of this specification. However, suffice it to say that a biasing mechanism such as a spring, whether a coil spring, the spring or the like a be provided for pushing the individual opposed locating lugs 14410 up against a détente (not shown). In another embodiment, the ornamental item 100 may have a locator and/or an electronic tracking attachment attached to the ornamental item 100 which could be used to keep track of a person on a dive boat as an example. Such a tracking system could be implemented using Bluetooth Low Energy (BLE) in which the BLE chip could be either an integral part of the ornamental item 100 or a separate item that could be attached to the ornamental item 100 using an adhesive or may be an integral part of the ornamental item 100.

The BLE device could be configured so as to communicate with a mobile device such as a user's mobile phone using one of a number of standard mobile phone apps which are available for use with BLE devices. Naturally, any such device would be required to be waterproof.

In alternative embodiments, it is envisaged that the ornamental item 1100 can be an electronic tracking device that gives off radio frequency signals that can be tracked by a tracking device. Such tracking devices are known, and a description of the workings of such tracking devices is considered beyond the scope of the present specification.

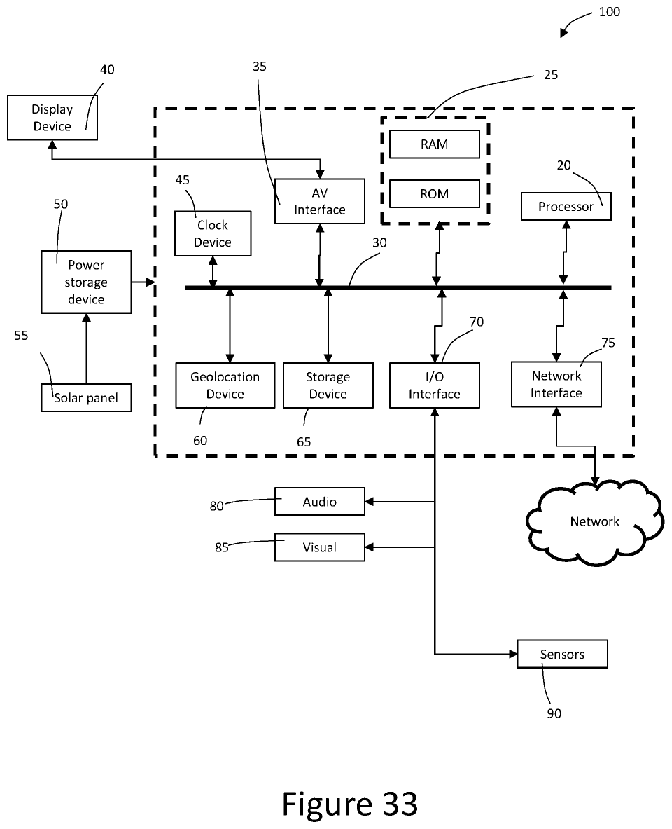

FIG. 33 shows an embodiment of an ornamental item 100, which could equally be located or associated with the engaging arrangement and/or base of an ornamental connector described above.

In the embodiment of an ornamental item 100 shown in FIG. 33, preferably housed within a housing, there is provided a processor 20 as well as memory modules 25 in the form of random access memory (RAM) and read-only memory (REM). The ornamental item is further provided with a communications bus 30 for facilitating communications between various componentry described. The ornamental item 100 is further preferably provided with an audiovisual interface 35 that is connectable, preferably via a communications Jack such as a USB port (not shown) to a display device 40. In an alternative embodiment, it is envisaged that the ornamental item 100 can include its own display device 40, for example a screen display or touch enabled screen.

The ornamental item further includes a clock device 45 that allows the processor to retrieve an accurate timestamp.

Further, the ornamental item 100 shown in FIG. 33, includes a geolocation or geo-positioning location device 60 that is configured for receiving geolocation signals from geo-positioning satellites. The ornamental item 100 can further include a power source 50 such as a battery, as well as a power generating device such as a solar panel 55.

Further included is a digital media storage device 65 on which data and/or software instructions can be stored. The ornamental item 100 can further be provided with an input output interface 70 that allows for signals to be received from and output to external devices such as audio devices 80 such as buzzers or speakers, visual devices 85 such as LED lights, as well as sensors 90 as will be described in more detail below.

The ornamental item further includes a transceiver that preferably allows for transmission and receiving of electronic signals in the form of a preferably wireless network interface 75. Preferably the network interface 75 is configured for transmission of signals over a network, such as the Internet, or a local network.

The transceiver is preferably configured for transmitting the received geolocation signals from geo-positioning satellites to a remote terminal, such as a smart phone or laptop. It is envisaged that the remote terminal may calculate the position of the ornamental connector from the geolocation signals, for display to a user. Alternatively, the processor 20 and software instructions stored on the digital media storage device 65 of the ornamental item 100 may be configured for calculating the position of the ornamental connector from the geolocation signals, and transmitting the calculated position as a position signal.

As mentioned above, the ornamental item 100 is provided with a clock device for retrieving the current time, and any signals received, stored or sent by the ornamental item 100 can be time stamped. Such a geo-positioning/tracking device may be useful for keeping track of, for example children on the beach.

Additionally and/or alternatively, as mentioned above, the ornamental item 100 and/or base and/or removable portion of the engaging arrangement can include sensors 90 for measuring a wide variety of characteristics, including UV radiation, wind speed, ambient light, or the like. In one embodiment, the sensor 90 is a UV radiation sensor. It is envisaged that the processor 20 and software stored on the digital media storage device 65 can be configured for recording the UV radiation levels as well as the amount of time that the sensor 90 has been subject to the detected UV radiation levels. It is envisaged that the instantaneous as well as cumulative UV radiation levels can be stored and/or transmitted.

The digital instructions or software can be configured for directing the processor to transmit a warning signal to a remote terminal when the amount of UV radiation (on either an instantaneous or cumulative basis) that the detector has been subjected to has reached a threshold amount, or if the detected UV radiation of any one or more readings exceeds a predetermined threshold. It is envisaged that using an ornamental connector as described in any of the embodiments would be advantageous for holding such a UV radiation detector in a position, for example close to a person's shoulders or neck on a neck strap, where a high incidence of UV radiation is expected to be encountered.

### Interpretation

### Markush Groups

In addition, where features or aspects of the invention are described in terms of Markush groups, those skilled in the art will recognise that the invention is also thereby described in terms of any individual member or subgroup of members of the Markush group.

### Chronological Sequence

For the purpose of this specification, where method steps are described in sequence, the sequence does not necessarily mean that the steps are to be carried out in chronological order in that sequence, unless there is no other logical manner of interpreting the sequence.

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

For the purposes of this specification, the term “plastic” shall be construed to mean a general term for a wide range of synthetic or semisynthetic polymerization products, and generally consisting of a hydrocarbon-based polymer.

As used herein the term “and/or” means “and” or “or”, or both.

As used herein “(s)” following a noun means the plural and/or singular forms of the noun.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the fashion and/or jewelry and/or tracking industries.

1-16. (canceled)

17. An ornamental connector for connecting an ornamental item to an elongate flexible member, the ornamental connector comprising:
a. a base, the base including an aperture through which the elongate flexible member is receivable in use;
b. an engaging arrangement configured for removably connecting the ornamental item to the base;
c. wherein the engaging arrangement includes an engaging formation, the engaging formation being engageable with the base to move between:
i. an engaged position in which the ornamental item is securely engaged with the base and is not removable therefrom; and
ii. a disengageable position in which the ornamental item is removable from the base;
d. a locking arrangement, the locking arrangement being moveable in a direction substantially transversely to the engaging formation relative to the base to move between a locked condition and an unlocked condition; and
e. wherein the locking arrangement is adapted to prevent movement of the engaging formation from its engaged position.

18. The ornamental connector as claimed in claim 17, wherein the ornamental connector includes an ornamental item.

19. The ornamental connector as claimed in claim 17, wherein the engaging formation is rotatable relative to the base to move between its engaged position and disengageable position.

20. The ornamental connector as claimed in claim 17, wherein the locking arrangement is moveable between a locked condition in which it prevents the rotatable engaging formation from moving from the engaged position in use, and an unlocked condition in which the rotatable engaging formation is moveable between the engaged position and the disengageable position.

21. The ornamental connector as claimed in claim 20, wherein the locking arrangement is adapted to be held in the locked condition by the elongate flexible member in use.

22. The ornamental connector as claimed in claim 17, wherein the locking arrangement includes an aperture that is aligned with the aperture in base for receiving the elongate flexible member in its locked condition.

23. The ornamental connector as claimed in claim 17, wherein the locking arrangement includes a slot for receiving a protrusion of the rotatable engaging formation.

24. The ornamental connector as claimed in claim 17, wherein the engaging arrangement includes a protrusion receivable into a slot in the base.

25. The ornamental connector as claimed in claim 24, wherein the engaging arrangement includes a T shaped protrusion.

26. The ornamental connector as claimed in claim 17, wherein the engaging arrangement is elongated in one direction.

27. The ornamental connector as claimed in claim 24, wherein the slot in the base is elongated in one direction.

28. The ornamental connector as claimed in claim 17, wherein the locking arrangement is receivable into one or more selected from an aperture and a recess in the base.

29. The ornamental connector as claimed in claim 17, wherein the locking arrangement is receivable into the base on a track.

30. The ornamental connector as claimed in claim 17, wherein the aperture includes a holding arrangement adapted to restrict movement of the elongate flexible member relative to the ornamental connector when in use.

31. An ornamental connector for connecting an ornamental item to an elongate flexible member, the ornamental connector comprising:
a. a base, the base including a recess through which the elongate flexible member is receivable in use, the recess being closeable by a closing arrangement to retain the elongate flexible member within the recess;
b. an engaging arrangement configured for removably connecting the ornamental item to the base;
c. wherein the engaging arrangement includes an engaging formation, the engaging formation being moveable relative to the base between:
i. an engaged position in which the ornamental item is securely engaged with the base and is not removable therefrom; and
ii. a disengageable position in which the ornamental item is removable from the base;
d. a locking arrangement, the locking arrangement being moveable relative to the elongate flexible member to move between a locked condition and an unlocked condition; and
e. wherein the locking arrangement is adapted to prevent movement of the engaging formation from its engaged position when in its locked condition.

32. The ornamental connector as claimed in claim 31, wherein the ornamental connector includes an ornamental item.

33. The ornamental connector as claimed in claim 31, wherein the locking arrangement is moveable in a direction substantially transversely to the elongate flexible member.

34. The ornamental connector as claimed in claim 31, wherein the locking arrangement includes a closure member.

35. The ornamental connector as claimed in claim 34, wherein the closure member is movable between an open position in which the elongate flexible member is receivable within the recess and a closed position in which the elongate flexible member is restricted from movement into or out of the recess.

36. The ornamental connector as claimed in claim 34, wherein the closure member is pivotably movable between an open position and the closed position.

37. The ornamental connector as claimed in claim 35, wherein the closed position of the closure member corresponds to the locked condition of the locking arrangement.

38. The ornamental connector as claimed in claim 35, wherein the open position of the closure member corresponds to the unlocked condition of the locking arrangement.

39. The ornamental connector as claimed in claim 31, wherein the locking arrangement includes a clasp for retaining the closure member in its closed position.

40. (canceled)

41. (canceled)

42. The ornamental connector as claimed in claim 31, wherein the ornamental item includes one or more selected from:
a. a geo-positioning/tracking device; and
b. a sensor configured for sensing environmental characteristics.

43. The ornamental connector as claimed in claim 31, wherein the sensor is a UV radiation sensor.

44. The ornamental connector as claimed in claim 17, wherein the ornamental item includes one or more selected from:
a. a geo-positioning/tracking device; and
b. a sensor configured for sensing environmental characteristics.

45. The ornamental connector as claimed in claim 17, wherein the sensor is a UV radiation sensor.
